(19) United States
(12) Patent Application Publication
(10) Pub. No.: US 2006/0281493 A1
(43) Pub. Date: Dec. 14, 2006

(54) Wireless communications system

(75) Inventors: Dharmayashdev Rai Basgeet, Bristol (GB); Khurram Ali Rizvi, Bristol (GB); Yuk Ching Chow, Bristol (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/407,974

(22) Filed: Apr. 21, 2006

(30) Foreign Application Priority Data
Apr. 22, 2005 (GB) 0508208.6

(51) Int. Cl. H04B 1/38

(52) U.S. Cl. 455/561; 455/444; 455/562.1

(57) ABSTRACT

A communication network comprises at least a first region serviced by a base station, and further comprises a plurality of bridging stations deployed around the base station so defining a circumference about said base station. Each bridging station comprises one or more directional antennas operable to generate a coverage area lying predominantly outside said circumference, so forming in operation an inner zone within said circumference wherein bridging station sensitivity and signal strength is significantly lower than that of the base station.

The present invention concerns communication of information within a wireless communications system. The invention is particularly concerned with wireless communications systems in which data is transmitted in a cellular network.

The third generation (3G) collection of telecommunications standards, established in 1998 and managed by the European Telecommunications Standards Institute (ETSI), represent telecommunications implementations that offer facility for transfer of data in packet formats. The essence of the 3G Standard is that the packet format allows transfer of data, regardless of its nature. Thus, voice data and information based data can equally be transferred. Further, multimedia data can be transferred, as it is capable of being placed in a packet form and transferred accordingly.

In view of the general desire by users for transfer of increasing quantities of multimedia data, and/or voice data, with improved quality of service, there is a general and continuing requirement to seek improvements to present systems to enable greater throughput of packet data in a system.

In particular, a further portfolio of standards is currently in development, which is provisionally known as 4G (fourth generation). 4G is intended to extend 3G capacity by at least one order of magnitude, and to offer an entirely packet switched network. Whereas 3G is at least partially backwards compatible and thus 3G networks often include equipment compliant with previous, possibly non-packet based, standards, 4G network elements are intended to be entirely packet based. The data rate available in 4G is expected to be 100 Mbps, and it is expected that this will develop to offer up to 1 Gbps.

Clearly, developments in the field of telecommunications are normally expected to result in further increases in data throughput, and so no upper limit on the performance63 of the present invention can be inferred from the current understanding of the targets currently stated as being attainable.

The latter figure is most likely to be offered in respect of mobile devices in use by pedestrians, rather than those in use in motor vehicles. This is because data rates may be compromised by relatively rapid movement of a mobile device.

Within this context, the field of the present invention will now be described with reference to mobile communications systems based on a cellular structure. A cellular structure is imposed in order to provide coverage and capacity to users of mobile devices in the geographical area covered by the mobile communications service (the service area). Generally, a mobile communications system is designed such that, at any point in the service area, communication can be established between a base station and a mobile station within the service area. This is achieved by positioning base stations, perhaps in a regular pattern, or as near as possible taking into account physical features on the landscape, such that base stations generally govern respective cells of the cellular structure. The base stations are connected together to form a network backbone. This backbone is typically implemented by hard-wired connections.

In order for a mobile communications system to be useful, a minimum standard of quality of service must be offered to a subscriber. This entails satisfying various technical criteria in the nature of the communications between mobile stations and base stations in the system. Among these criteria are the coverage (i.e. the extent of the service area) and the capacity of the system. A subscriber will be dissatisfied with the quality of service if, while travelling, the mobile station enters a region with little or no coverage provided by communication with base stations and/or relays. Furthermore, a subscriber will also become dissatisfied if, when requesting a connection of a telephone call, the network is at capacity.

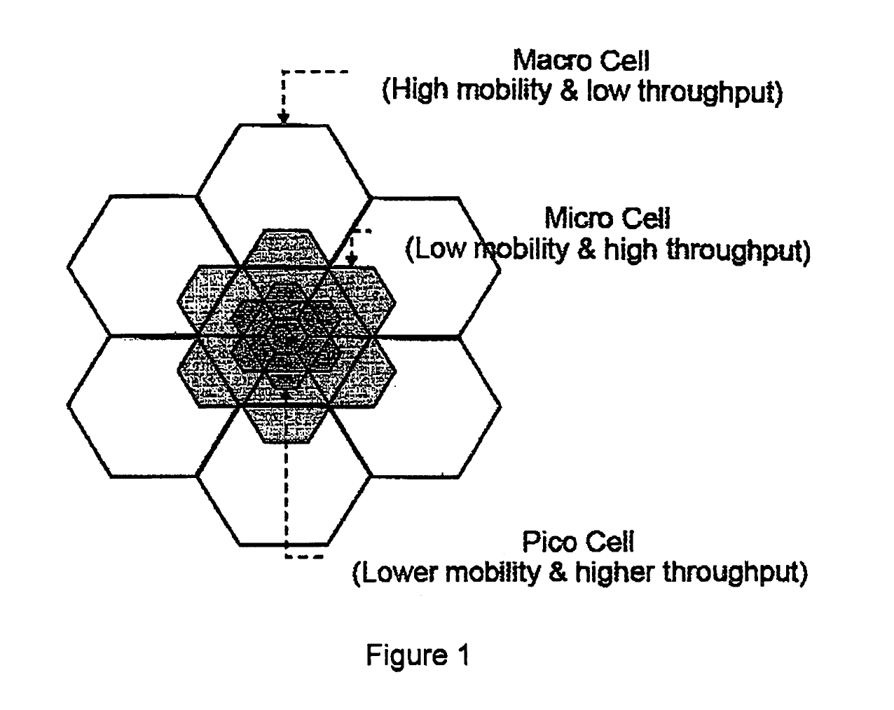

FIG. 1 illustrates an exemplary embodiment of an arrangement compliant with the 3G standard to provide improved coverage and enhanced capacity. It comprises, as illustrated, base stations (not shown), each base station having a beam pattern that, by convention is illustrated as substantially hexagonal (by virtue of six angularly spaced antennas). By virtue of these hexagonal beam patterns, a cellular field pattern can be established by virtue of regularly spaced base stations. This defines a wider, macro cell structure covering the service area. The macro cell provides the facility for communication between the base station of that cell and mobile stations within that cell with high levels of mobility but potentially low throughput of data. On top of that, a further array of base stations is deployed each offering a smaller coverage area, again, in this exemplary arrangement, substantially hexagonal, so providing a micro cell. A micro cell is characterised as offering higher throughput of data than in the macro cell, but at the expense of mobility of mobile stations within the micro cell. That is, micro cells are smaller, leading to more frequent instances of handover from one micro cell to another. Yet a further layer of cellular structure, with cells being still smaller than the micro cells, are provided by a further deployment of base stations. These cells are therefore termed picocells. Again, these further suffer with regard to mobility of mobile stations, in that the number of handovers required for a mobile station travelling at a given speed is far greater than with regard to a macro cell structure, but the intensity of transmission, and the adjacency to a base station allows greater throughput of data.

Therefore, the major disadvantages of this approach are the substantial increase in the cost of infrastructure due to the additional deployment of base stations on the network backbone, increased network structure due to the need to effect communication between the additional base stations, and the organisational requirements relating to the arrangement of base stations into macro-, micro- and pico-cell networks, and that throughput of data is variably limited, offering 384 Kbps for vehicle based mobile stations and 2 Mbps for stationary and near stationary mobile stations. Moreover, there is substantial signalling traffic on the backbone due to the handovers between cells and between overlapping layers of the cell hierarchy.

In addition, the wireless medium which is used in a mobile communications system with this cellular structure is somewhat unpredictable. This is due to the existence of multi-path effects brought about by the presence of physical structures in the landscape such as buildings and topographical features. Multi-path propagation can be deleterious to the successful operation of wireless communications in such a system, as it adds noise to a signal in the form of echoes of the signal itself. This noise can be sufficient to cause the termination of an active telephone call. Such termination is highly undesirable from the point of view of the provider of a network service (the network operator) and certainly unacceptable from the point of view of the user of a mobile telephone device (the subscriber).

To overcome the problem of multi-path propagation and its impact on the quality of service experienced by a subscriber, it is known for a network operator to employ one or more relays, or repeaters. It will be appreciated that the terms ‘relay’ and ‘repeater’ are used interchangeably within the existing literature. These are positioned with respect to the base stations in the service area, in order to extend the coverage of the cellular parts of the service area associated with the base stations, so as to enhance the connectivity between the mobile station and the base station. A relay operates on the basis of blindly relaying received signals toward its respective base station. That is, a relay does not perform a decoding function and so cannot enhance any quality of service characteristics associated with the received data at the relay. Thus, a mobile station that is covered by the coverage of a relay simply receives a boost in signal strength.

Badruddin, N., and Negi, R., “Capacity improvement in a CDMA system using bridginging,” in Wireless Communications and Networking Conference, 2004, WCNC. 2004 (IEEE, Volume: 1, 21st-25th Mar. 2004, Pages 243-248) propose an enhanced relay system for CDMA based cells that also improves capacity. In this paper, Badruddin and Negi note that there is a significant interference problem for relays, when mobile stations (MSs) relatively near the relay are communicating directly with a more distant base station (BS) at high power. Such a situation may occur, for example, when an MS is 0.9 km from a base station while the relay is 1.0 km from the base station. This interference impacts upon capacity.

Badruddin and Negi propose a time division multiplexing (TDM) scheme wherein for each of three timeslots, direct communicating MSs in one 120° segment of the cell and relayed MSs in the opposite 120° segment of the cell occupy one time slot, forming a bow-tie arrangement of reciprocal segments. This maximises the distance between direct communicating MSs and active relays and so minimises the interference between them. This results in greater capacity, but has the significant disadvantage that to maintain throughput in the TDM scheme requires transmissions at three times the original data rate to allow each 120° segment to directly and indirectly communicate in sequence.

To limit this problem, the paper then suggests using six 60° segments so that, for example, in a first time slot segments 1, 3 and 5 allow direct communication, while segments 2, 4 and 6 allow relayed communication. In a second time slot, these modes swap. Whilst this preserves the arrangement that the opposite segment is always in the opposite mode, now the adjacent segments are also in the opposite mode and so there is less mitigation of interference at each relay, reducing the improvement in capacity, This scheme still uses a TDM scheme with two time slots, and so still requires a doubling in data rate to maintain throughput.

Also, both schemes require exact timing between MSs, relays and the base station to operate the time division multiplexing.

Consequently, it is desirable to find an improvement in relation to throughput and mobility for a cell that aims to limit the above disadvantages. The present invention intends to offer a solution.

In a first aspect of the present invention, a bridging station for wireless communication comprises at least a first directional antenna operable to generate a coverage area facing predominantly outward with respect to a base station.

In a configuration of the above aspect the one or more directional antennas are operable to generate a coverage area lying predominantly outside a circumference, said circumference defined with respect to the base station and substantially coincident with said bridging station.

In another configuration of the above aspect, each bridging station uses one uplink and one down link communication scheme with mobile stations that it is in communication with, but uses different communication schemes to communicate with the base station.

In a further configuration of the above aspect, the bridging stations communicate with the base station via line of sight narrow beam wireless links facing the base station.

In an alternative configuration of the above aspect at least one bridging station communicates with the base station via a DSL link.

In one aspect of the present invention, a base station comprises wireless communication means operable to communicate with mobile stations within a coverage area, and further comprises high-bandwidth communication means operable to communicate with a plurality of bridging stations.

In a configuration of the above aspect, the base station communicates with the bridging stations via line of sight narrow beam wireless links oriented towards the bridging stations.

In another aspect of the present invention, a communication network comprises at least one cell served by a base station, the cell also being populated by bridging stations that surround the base station to form a circumference of unspecified shape, wherein the bridging stations comprise one or more directional antennas operable to generate a coverage area lying predominantly outside said circumference, causing an effective inner zone within the circumference around the base station where bridging station sensitivity and signal strength is significantly lower than that of the base station for any MS within the inner zone.

In a configuration of the above aspect the bridging stations are deployed in line of site with the base station and are arranged in operation to communicate with the base station via narrow beam wireless links.

In another aspect of the present invention, a method of wireless communication comprises the steps of arranging bridging stations to surround a base station, and configuring the transmit and receive directionality of the bridging stations to give a coverage area facing predominantly outward with respect to the base station.

In a configuration of the above aspect, bridging stations give a coverage area lying predominantly outside a circumference, said circumference defined with respect to the base station and substantially coincident with said bridging station.

In a configuration of the above aspect, the base station power management is configured to provide the smallest coverage area that maintains continuity of coverage with the plurality of bridging stations.

In yet another aspect of the present invention, a method of network cell planning or replanning involves configuring the directionality of bridging stations so as to provide a desired coverage area lying predominantly beyond a circumference substantially defined about the base station by said plurality of bridging stations.

In a configuration of the above aspect, cell planning further involves determining locations for a selected plurality of bridging stations about a base station.

In another aspect of the present invention, a data carrier comprises computer readable instructions

In a configuration of the above aspect, the instructions, when loaded into a computer, cause the computer to operate as a bridging station.

In a configuration of the above aspect, the instructions, when loaded into a computer, cause the computer to operate as a base station.

In a configuration of the above aspect, the instructions, when loaded into a computer, cause the computer to operate as a network controller.

Embodiments of the present invention will now be described by way of example with reference to the accompanying drawings, in which:

FIG. 1 is a schematic diagram of a 3G cellular network and resulting coverage scheme

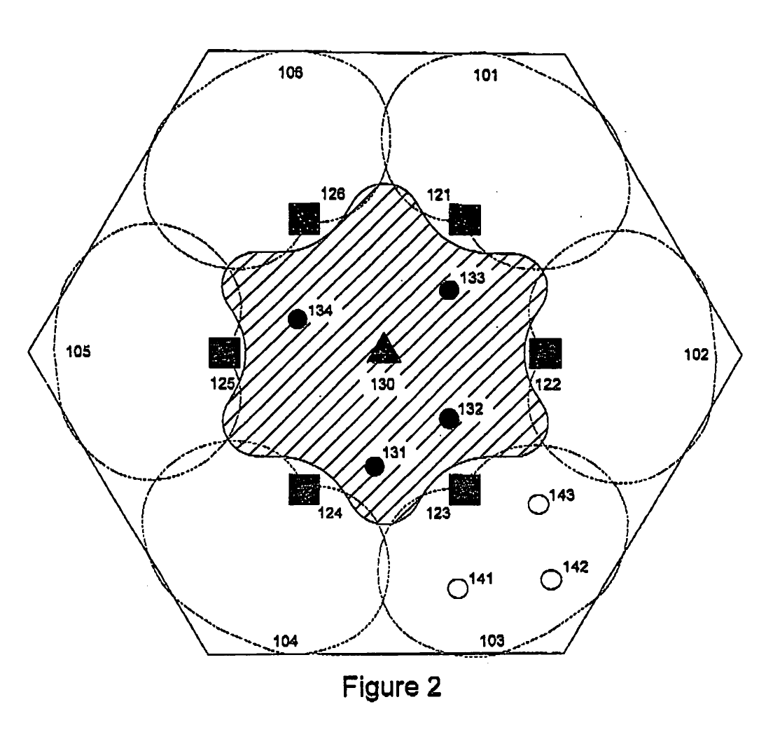

FIG. 2 is a schematic diagram of a base station and bridging stations in accordance with an embodiment of the present invention illustrating the resulting areas of coverage.

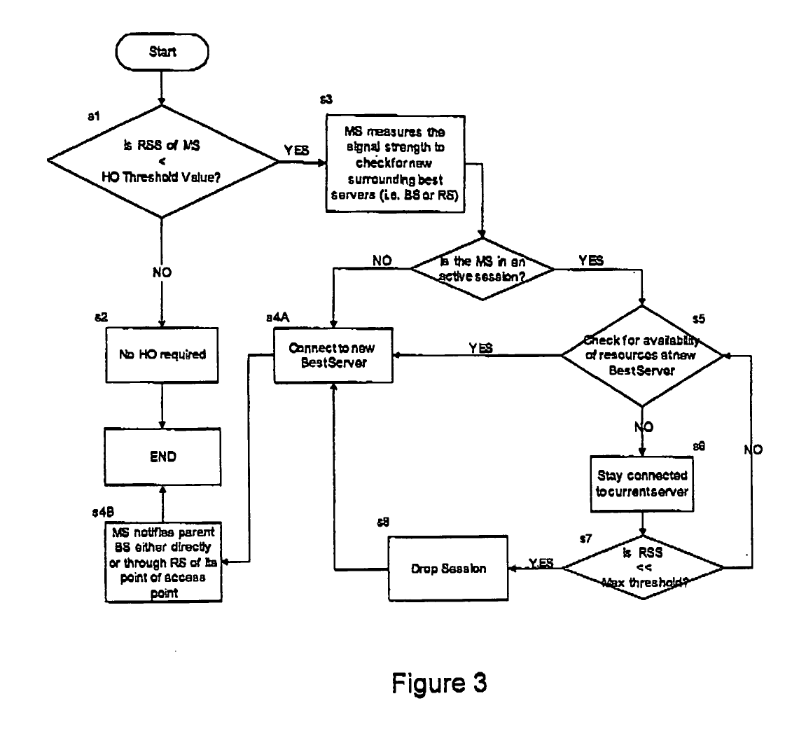

FIG. 3 is a flow chart depicting a handover process in accordance with an embodiment of the present invention.

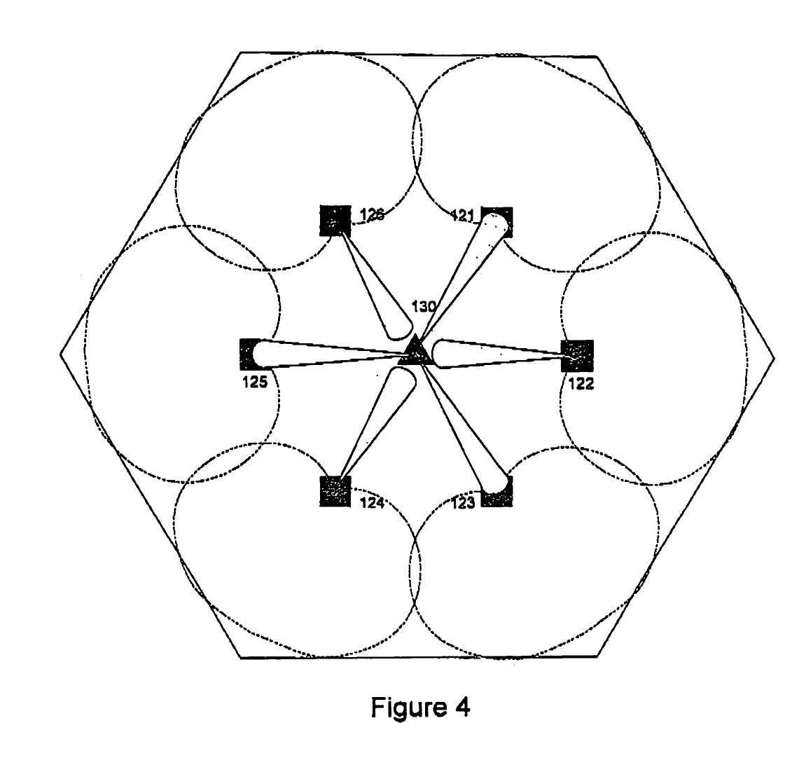

FIG. 4 is a schematic diagram of a base station and bridging stations in accordance with an embodiment of the present invention, illustrating communication between the base stations and bridging stations.

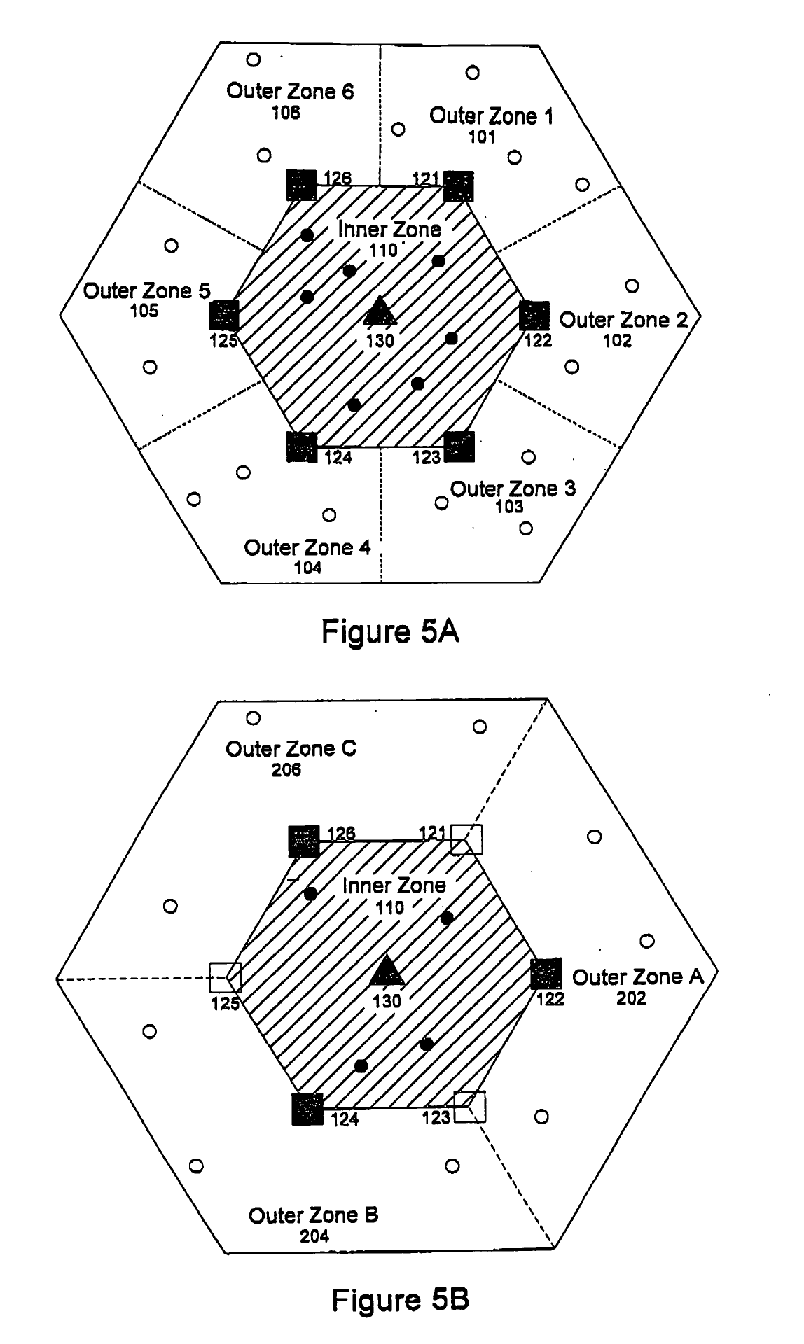

FIGS. 5A and 5B are schematic diagrams of a base station and bridging stations in accordance with an embodiment of the present invention, illustrating high and low rate traffic configurations respectively.

A wireless communication system is disclosed. In the following description, a number of specific details are presented in order to provide a thorough understanding of embodiments of the present invention. It will be apparent, however, to a person skilled in the art that these specific details need not be employed to practice the present invention.

Referring now to FIG. 2, in an embodiment of the present invention, a base station (BS) 130 is connected to the cellular network backbone (not shown), for example via a wireline connection to a mobile switching centre (not shown). Deployed at a distance around the base station (BS) are bridging stations (BRS) 121-126 that are not connected to the backbone. The term ‘bridging station’ is derived from the acronym for ‘Basestation Relay Integration Device for Generic Enhancements’.

The bridging stations 121-126 comprise beam-forming antenna arranged to provided communication in a substantially outward direction in relation to the base station 130. Thus each bridging station provides a respective outward facing coverage area 101-106.

In consequence, mobile stations (MS) 131-134 located between the base station and the deployed bridging stations only perceive the base station 130 and so communicate with it directly.

In contrast, mobile stations 141-143 located beyond the deployed bridging stations, but within one of the outward facing coverage areas 101-106, perceive both the BS 130 and one or more BRSs, but select the BRS with the strongest signal (for example, on an broadcast channel) with which to communicate.

The effect is to create two zones within the cell; an inner zone where an MS only sees the base station and so communicates directly with it (denoted by the hatched area in FIG. 2), and an outer zone comprised of coverage areas 101-106 where an MS elects to communicate with a nearby bridging station.

Advantageously, the directionality of the bridging stations 121-126 means that not only do MSs in the inner zone not perceive the bridging stations, but the bridging stations 121-126 also do not perceive MSs from the inner zone, and so do not suffer interference from these MSs.

Similarly advantageously, MSs in the outer zone will adjust their power output to communicate with the closest BRS, and so minimise the interference they cause at the BS 130 and to neighbouring BRSs.

Thus, a significant overall reduction in interference and corresponding increase in capacity is achieved without the disadvantages of either time division multiplexing or hierarchical arrangements of sub-cells, as experienced in the prior art.

It will be understood that in practice, some incidental signals from the each zone may be perceived in the other. For example, a (heavily attenuated) signal from an MS in the inner zone may reach an BRS due to back-scattering by a building in the outer zone. Similarly, whilst most directional antennas are predominantly sensitive in the preferred range of direction, there may be residual sensitivity in other directions. Thus an BRS may perceive an MS from the inner zone, but at a significantly attenuated sensitivity when compared to an MS in its own outward facing coverage area. Conversely an MS in the inner zone may perceive an BRS, but as a comparatively faint signal.

Thus in practice, the bridging stations can be thought of as being deployed to form a circumference about the base station, wherein the bridging station signal strength within the circumference is insignificant, and wherein a bridging station's signal strength outside the circumference is predominant within each respective bridging station's coverage area. Consequently, the area within the circumference forms the inner zone, and the bridging station coverage areas form the outer zone.

In an embodiment of the present invention, an MS roving within a cell can be handed over between bridging stations and the base station according to a mobile controlled handover.

Referring now to FIG. 3, in step s1, a mobile station determines whether the received signal strength from the current serving base station or bridging station has dropped below a given threshold. If it has not, then in step s2 there is no need for a handover.

However, if it has dropped below the threshold, then in step s3 a server discovery process determines the signal strength of measurable servers, both BRS and BS. If the MS is not currently in a session, then in step s4A it connects to the new BRS or BS server, and in step s4B notices the base station (indirectly, if connecting to a bridging station) of its point of access point.

If the MS is currently in a session, then in step s5 the MS checks for the availability of resources at the selected server. If resources are available, then the MS connects as in step s4A. If resources are not available, then in step s6 the MS stays with the current server. As long as the received signal strength is low, the MS will check for resource availability at the alternative server. However if at step s7 the received signal strength is determined to drop below a second threshold, then at step s7 the connection is dropped and the MS connects to a better server as per step s4A.

Clearly, if during this process the received signal strength at the current server improves again, such that it exceeds the handover threshold value, then the handover process may be exited at any point.

Referring now to FIG. 4, as the bridging stations 121-126 are not connected to the cellular network backbone, in an embodiment of the present invention they also comprise means to communicate directly with the base station 130 via a communications link other than that used for normal BS-MS communications. Preferably the link is a narrow-beam, high bandwidth two-way wireless link with line-of-sight between the base and bridging stations. In FIG. 4, the base station 130 is shown, for the purposes of example only, transmitting to bridging stations 121, 123 and 125, and receiving transmissions from bridging stations 122, 124 and 126.

Alternative communications links include laser light or infrared light modulated to provide a communications link, or a wireline link utilising pre-existing infrastructure, for example SDSL over a public switched telephone network. Such a wireline link may have limited bandwidth and so may be more suitable to a bridging station serving a relatively low traffic area; for example, one floor of an office, or where the topology makes a wireless link unfeasible.

In an embodiment of the present invention, whilst the link between BRS and BS may be different from that between an MS and BS, the BS will process the signals from the BRS as if it were a cluster of MSs in that position. Consequently the processing of MS connections via an BRS is transparent to the base station.

In an embodiment of the present invention, the bridging stations 121-126 facilitate communication between an MS in the outer zone and the BS 130 in the inner zone by acting as if part of an ad-hoc network, allowing communication between the MSs in the outer zone and the BS 130 via hops to the relevant BRS. Mechanisms for establishing ad-hoc networks are well known in the art. Due to the fixed nature of the bridging stations, however, it is anticipated that only two hops (from MS to BRS and from BRS to BS) are necessary.

It will be appreciated that whilst in FIGS. 2 and 4 there are six bridging stations, evenly distributed and each covering an area of similar size, in practice any suitable number of bridging stations may be deployed and may have substantially outward looking coverage areas applicable to the topology and traffic requirements within the overall cell region. Thus the circumference identifying the inner and outer zones may be arbitrary in shape, and the density of bridging stations may vary to create micro-cell and pico-cell sized coverage zones where applicable.

Embodiments of the present invention described herein provide a number of other advantages, of interest for a number of cellular network systems and in particular for 4G cellular networks.

As can been seen when comparing 2G and 3G networks, the range of BSs tends to get smaller as the provided data rate increases, and hence more base stations are required to cover a given area. The use of bridging stations that do not need access to the network backbone is a particularly simple means to improve coverage and capacity for such high rate networks.

In addition, the differing links between MS and BRS, and BRS and BS mean different types of transmission scheme can be employed for these links.

For the MS-BRS link, in one embodiment of the present invention a receive diversity technique is applied at the BRS receiver, to improve uplink quality between MS and BRS for any type of MS. In another embodiment of the present invention, a transmit diversity technique is applied at the BRS transmitter to improve downlink quality for MSs suitably adapted to receive such signals. Clearly, these two embodiments may be combined.

In yet another embodiment, the BRS and MS employ multiple output, multiple input (MIMO) technology, which helps to improve quality of service.

For the BRS-BS link, higher complexity solutions may be considered for transmit and receive diversity techniques. Also, as noted previously, narrow directional beam transmissions may be employed to minimise multi-path propagation in this part of the overall MS-BS relayed link. It will also be appreciated that careful line-of sight positioning of BRSs will reduce multi-path propagation further.

Another issue for high-speed wireless data networks is the comparatively short battery life of the mobile stations. The populating of a cell with nearby bridging stations, and the reduction in overall interference, both reduce the transmit power requirement at the MS, improving battery life for portable devices.

In addition, the solution provided by embodiments of the present invention described herein is scalable. FIGS. 5A and 5B illustrate an idealised deployment of inner and outer zones in a hexagonal cell, for day and night time communication levels, or traffic.

Referring to FIG. 5A, in an embodiment of the present invention, all six bridging stations 121-126 are active to handle the levels of traffic encountered during peak daytime hours in outer zones 1 to 6. However at night, referring to FIG. 5B, bridging stations 121,123 and 125 may switch off, as the remaining bridging stations 122, 124 and 126 can accommodate the reduced traffic over a wider coverage range in outer zones A to C.

It will be appreciated that in this embodiment each, or at least the nighttime, bridging stations will have sufficient sensitivity to cover a sufficient proportion of their neighbouring BRS coverage areas to allow overlap of coverage at night. This may be a fixed property, or sensitivity/transmit power may change (if necessary) when the night time configuration switches on.

It will be appreciated that day and night are merely illustrative of traffic level patterns, and the deployment and suspension of bridging stations may be adapted to the traffic profile of that specific cell. Similarly, the deployment and suspension of bridging stations may be adaptive to current traffic levels in the cell, for example to mitigate the effects of cell breathing.

In an embodiment of the present invention, it is not necessary for the coverage area of the BS to be maintained so as to match the extent of the cell, as the BRSs provide communication links with MSs in the outer zone. In consequence, the base station power management may be configured to provide the smallest coverage area that maintains continuity of coverage with the plurality of bridging stations.

Referring to FIG. 5A again, it is clear that opposing outer zone pairs 101 and 104, 102 and 105, and 103 and 106 will experience the smallest cross-interference in the cell, as they direct their coverage away from each other and are separated by the inner zone. This minimal interference may advantageously facilitate re-use of CDMA codes in opposing outer zone pairs. Also of benefit to CDMA systems, the computational overhead at the base station associated with multiple user detection may be alleviated by the communication with the MS being at one remove and distributed amongst the bridging stations.

It will be clear to a person skilled in the art that the present invention is suited to other wireless architectures where mobile communications devices link to a central station that in turn links to a wireline infrastructure, such as wireless local loop.

It will also be clear to a person skilled in the art that communication between base stations and bridging stations may be in a different frequency band to communication for either with mobile stations. For example, communication with mobile stations may be in a 4G-licensed band, whilst communication between base and bridging stations may be centred at a higher frequency suitable for higher bandwidth communications.

A method of wireless communication is also provided, incorporating the steps of deploying a plurality of bridging stations about a base station, to form an approximate circumference about said base station, and;

configuring the directionality of the bridging stations so as to provide a coverage area lying predominantly beyond said circumference.

Similarly, a method of network cell planning incorporates the steps of identifying locations for a selected plurality of bridging stations about a base station, and configuring the directionality of said bridging stations so as to provide a desired coverage area lying predominantly beyond a circumference substantially defined about the base station by said plurality of bridging stations.

For a network in which the physical deployment of stations has already occurred, it is common to occasionally employ re-planning to account for seasonal or demographic changes in traffic. In an embodiment of the present invention, a method of network cell re-planning incorporates the step of configuring the directionality of bridging stations in a cell so as to provide a desired coverage area lying predominantly beyond a circumference substantially defined about a base station by said plurality of bridging stations.

Similarly, cell maintenance and optimisation methods will incorporate the step of configuring the directionality of bridging stations in a cell so as to provide a desired coverage area lying predominantly beyond a circumference substantially defined about a base station by sad plurality of bridging stations. The may also incorporate the step of configuring the directionality of bridging and/or base station in response to the activation and deactivation of bridging stations.

It will be clear to a person skilled in the art that embodiments of the present invention may be implemented in any suitable manner to provide suitable apparatus or operation; in particular, a bridging station may consist of a single discrete entity, a single discrete entity, multiple entities added to a conventional host device such a s a computer, or may be formed by adapting existing parts of a conventional host device such as a computer. Alternatively, a combination of additional and adapted entities may be envisaged. For example, components used in the manufacture of base stations may be used in the construction of bridging stations when suitably reconfigured. Thus adapting existing parts of a conventional device may comprise for example reprogramming of one or more processors therein. As such the required adaptation may be implemented in the form of a computer program product comprising processor-implementable instructions stored on a storage medium, such as a floppy disk, hard disk PROM, RAM or any combinations of these or other storage media or signals.

Similarly it will be clear to a person skilled in the art that the method of network cell planning may be implemented by a network controller under instruction from processor-implementable instructions stored on a storage medium.

It will be understood that embodiments of the present invention provide some or all of the following advantages:
i. Low cost deployment of bridging stations without connection to the cellular network backbone;
ii. Significant reduction in interference at the bridging station due to directionality of transmit/receive sensitivity in relation to the base station, enabling an increase in cell capacity;
iii. Transparency of bridging stations to base station;
iv. Scope to provide different transmission schemes suited to the equipment in use at each hop, improving efficiency of use of the available spectrum.

1. A bridging station for wireless communication comprising one or more directional antennas operable to generate a coverage area lying predominantly outside a circumference, said circumference defined with respect to a base station and substantially coincident with said bridging station.

2. A bridging station in accordance with claim 1 further arranged in operation to use a first communications scheme in communications with mobile stations within the bridging station's coverage area, and a second communications scheme in communications with the base station.

3. A bridging station in accordance with claim 1 further arranged to communicate with the base station via a line of sight narrow beam wireless link oriented towards the base station.

4. A bridging station in accordance with claim 1 further arranged to communicate with the base station via a DSL link.

5. A base station for wireless communication comprising wireless communication means operable to communicate with mobile stations within a coverage area, and further comprising communication means operable to communicate with a plurality of bridging stations that may each communicate with the base station at a higher bandwidth than a single mobile station.

6. A base station in accordance with claim 5 wherein the base station further comprises via a line of sight narrow beam wireless link oriented towards each respective bridging station.

7. A communication network comprising at least a first region serviced by a base station, and further comprising a plurality of bridging stations deployed around the base station so defining a circumference about said base station, wherein each bridging station comprises one or more directional antennas operable to generate a coverage area lying predominantly outside said circumference, so forming in operation an inner zone within said circumference wherein bridging station sensitivity and signal strength is significantly lower than that of the base station.

8. A communication network according to claim 7 wherein the bridging stations are deployed in line of site with the base station and are arranged in operation to communicate with the base station via narrow beam wireless links.

9. A method of wireless communication comprises the steps of
deploying a plurality of bridging stations about a base station, to form an approximate circumference about said base station, and;
configuring the directionality of the bridging stations so as to provide a coverage area lying predominantly beyond said circumference.

10. A method of wireless communication according to claim 9 further comprising the step of configuring the base station power management to provide the smallest coverage area that maintains continuity of coverage with the plurality of bridging stations.

11. A method of network cell planning comprising the steps of
determining locations for a selected plurality of bridging stations about a base station, and;
configuring the directionality of said bridging stations so as to provide a desired coverage area lying predominantly beyond a circumference substantially defined about the base station by said plurality of bridging stations.

12. A network controller operable to configure cells in accordance with the method of claim 11.

13. A method of network cell re-planning comprising the step of
configuring the directionality of said bridging stations so as to provide a desired coverage area lying predominantly beyond a circumference substantially defined about the base station by said plurality of bridging stations.

14. A network controller operable to reconfigure cells in accordance with the method of claim 13.

15. A wireless communications network comprising a network controller in accordance with claim 12.

16. A data carrier comprising computer readable instructions that, when loaded into a computer, cause the computer to operate as a bridging station in accordance with claim 1.

17. A data carrier comprising computer readable instructions that, when loaded into a computer, cause the computer to operate as a base station in accordance with claim 5.

18. A data carrier comprising computer readable instructions that, when loaded into a computer, cause the computer to operate as a network controller in accordance with claim 12.
